(19) United States
(12) Patent Application Publication
(10) Pub. No.: US 2005/0074555 A1
(43) Pub. Date: Apr. 7, 2005

(54) Producing method for die coater and coating apparatus

(75) Inventor: Shigetoshi Kawabe, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: KONICA MINOLTA MEDICAL & GRAPHIC, INC., Tokyo (JP)

(21) Appl. No.: 10/955,464

(22) Filed: Sep. 30, 2004

(30) Foreign Application Priority Data
Oct. 7, 2003 (JP) JP2003-348027

(51) Int. Cl. B05D 3/02

(52) U.S. Cl. 427/355; 427/384

(57) ABSTRACT

A method of producing a die coater structured with at least two bars so as to form a pocket section to extend a coating liquid in a coating width direction, a coating liquid supply port to supply a coating liquid to the pocket section, and a slit section to discharge a coating liquid from the pocket section to a material to be coated, wherein at least a part of a surface of the two bars coming in contact with a coating liquid is covered with a fluorine-based resin, the method comprises a covering process of covering a part of a surface of a bar coming in contact with a coating liquid with a fluorine-based resin; and a baking process of baking the fluorine-based resin covering the part of the surface of the bar at a temperature of 100 to 380° C.

### BACKGROUND OF THE INVENTION

The present invention relates to a coating apparatus provided with a die coater having at least 2 bars mounted thereon and to a method of manufacturing the die coater, and specifically, relates to a coating apparatus provided with a die coater having at least 2 bars with an excellent cleaning ability mounted thereon and to a method of producing the die coater having at least 2 bars mounted thereon, wherein the coating apparatus causes few coating failures and achieves an excellent coating quality.

In the prior art, as a method for coating a continuously running belt-shaped support or a base board (hereinafter, also referred to as “support”) with a liquid coating composition (for example, liquid coating compositions for subbing, overcoating, and a backside layer) for surface treatment of materials such as photographic photosensitive materials, heat development recording materials, abrasion recording materials, magnetic recording media, glass plates, steel plate, etc., there are known methods such as dip coating methods, blade coating methods, air knife coating methods, wire bar coating methods, gravure coating methods, reverse coating methods, reverse roll coating methods, extrusion coating methods, slide coating methods, and curtain coating methods.

Among these, slide coating methods, extrusion coating methods, and curtain coating methods allow high speed coating, thin layer coating, and simultaneous multi-layer coating, and accordingly, are widely used in coating photographic photosensitive materials, heat development recording materials, and abrasion recording materials. Serving as coating apparatuses to be used in these coating methods, there are used slide type die coaters for slide coating methods, extrusion type die coaters for extrusion coating methods, and curtain type die coaters for curtain coating methods.

These die coaters are produced having at least two bars mounted thereon, and regarding the structure of the die coaters, in the case of a slide type die coater, for example, the die coater has at least 2 bars and is comprised of a slit section that is constructed of at least 2 bars and lets a liquid coating composition flow out, a liquid storing section called as a pocket section for supplying the liquid coating composition uniformly in the lateral direction of the slit section, a sliding section on which the liquid coating composition having flowed out of the slit section flows, and a lip section for forming beads between the end of the sliding section and a support to coat the support with the beads of the liquid coating composition. The slit section, the pocket section, the sliding section, the lip section, and an outer wall that is continuous with the lip section, are portions that come in contact with the liquid coating composition.

As for performing coating of a liquid coating composition for a photographic photosensitive material containing silver halide grains or a heat development recording material by the use of a slide type die coater, an extrusion type die coater, and a curtain type die coater, it is known that a portion, of the various die coaters, which comes in contact with the liquid coating composition has the following problem.

Regarding an outer wall continuous with a lip section, when a flow rate is set at the start of coating and when coating is terminated, a liquid coating composition flows down along the outer wall continuous with the lip section, adheres to the outer wall, and then gets dry and solidifies, which makes cleaning after the termination of coating painstaking.

Tiny foreign materials and silver halide grains may adhere to the slit section, the pocket section, the sliding section, and the lip section. In the course of coating for a long time, tiny foreign materials and silver halide grains adhering to these sections turn into a core, then further foreign materials and silver halide grains adhere to the core, and thus such created an adhering deposit may grow.

If the deposit grows to a certain extent in this way, the rate and the flow speed of a liquid coating composition vary at the deposit, which makes the flow of the liquid coating composition unstable, resulting in a coating failure and difficulty in production.

It is understood that these foreign materials and silver halide grains appear, for example, in such a way that foreign materials adhering to dead spaces of joint sections and valves of pipes which are disposed in a complex liquid coating composition supply system extending from a liquid coating composition supply pipe to the exit of a slit section of a die coater are torn off by conveying the liquid coating composition, and silver halide deposits in the liquid coating composition to become grains in the course of coating of the liquid coating composition for a long time.

Particularly, at a start of coating, a liquid coating composition is rapidly conveyed into a liquid coating composition supply system, which tears off tiny foreign materials adhering to the respective dead spaces of the liquid coating composition supply system, and then the foreign materials adhere to portions of the die coater where the die coater contacts with the liquid coating composition.

Moreover, a coating solution adheres also to the outer wall which leads to a lip part, and dries and becomes a solid.

For coating for a long time, there are known the following solutions that prevent silver halide grains deposited in a liquid coating composition and tiny foreign materials from adhering to portions, of a die coater, which contact with the liquid coating composition, and allow stable coating and easy cleaning after termination of coating.

For example, there is known a technology in which a pocket section, a slit section, etc. of an extrusion type die coater are formed with a fluorine based resin so that cleaning and disassembling are easy (referring to Patent Documents 1 and 2, for example).

Another technology is known in which the periphery of a slit section of an extrusion type die coater is lyophilized with a fluorine based resin to allow forming of a thin layer without a streak type unevenness (referring to Patent Document 3, for example).

Still another technology is known in which the outer wall side surface of an extrusion type coater for coating base materials is covered with a fluorine based resin to prevent retention of a liquid coating composition at a start of coating and to achieve uniform layer thickness (referring to Patent Document 4, for example). The technologies disclosed in the above stated Patent

Documents 1 to 4 are so sophisticated as to allow it to prevent adherence of foreign materials by covering portions of a die coater, the portions coming in contact with a liquid coating composition, with a fluorine based resin, but these technologies have the following problem.

In a process of covering bars with a fluorine based resin for a bar, a baking process deteriorate the straightness of the bars, and when a die coater is produced having these bars mounted thereon, the gap of a slit section in the lateral direction of coating and the distance between the die coater and an object to be coated become uneven to lower the uniformity of thickness of a layer in the lateral direction of coating, which may have resulted in a fear that coating cannot be achieved.

As a coating layer thickness is required to be accurate, the straightness of a die coater is also required to have an accuracy of a few micrometers. When carrying out a covering process to cover the fluorine based resin on a bar, and in the case that coating width is less than about 1 m or less, an influence of the heat treatment at the time of the covering process hardly causes a problem. However, in the case of a bar used for a die coater having a coating width exceeding 1 m, the influence of heat treatment in a fluorine based resin covering process is so significant that although a die coater produced having bars covered with the fluorine based resin is allowed to prevent coating failures due to deposition of a liquid coating composition, but the die-coater is not allowed to attain uniformity of layer thickness in the lateral direction of coating, thus only permitting coating that does not require a quality with uniformity of the coating layer thickness. For this reason, in order to suppress generating of coating defects, without carrying out a covering process of the fluorine based resin, a coating was not performed for a long time, but cleaning was conducted frequently, resulting in that the rate of operation of a manufacturing process is lowered.

Therefore, there have been a demand for a coating apparatus using a die coater with a width of 1 meter or longer and a method of producing the die coater, the die coater having portions that come in contact with a liquid coating composition and have been subjected to covering with a fluorine based resin to achieve products that are coated with a uniform coating thickness in the lateral direction of coating and have few coating failures.
[Patent Document 1] TOKKAI No. H11-156265
[Patent Document 2] TOKKAI No. 2001-269606
[Patent Document 3] TOKKAI No. 2001-191004
[Patent Document 4] TOKKAI No. 2001-276709

### SUMMARY OF THE INVENTION

With the background stated above, an object of the invention is to provide a coating apparatus using a die coater with a width of 1 meter or longer and a method of producing the die coater, the die coater having portions that come in contact with a liquid coating composition and have been subjected to covering with a fluorine based resin to achieve products that are coated with a uniform coating thickness in the lateral direction of coating and have few coating failures can be achieved.

The above-described object has been attained with the following items.

(Item 1)

In a coating apparatus comprising a pocket section for extending a liquid coating composition in the lateral direction of coating, a liquid coating composition supply inlet for supplying the liquid coating composition (coating liquid) to the pocket section, and a slit section for ejecting the liquid coating composition from the pocket section to an object to be coated, and employing a die coater having at least 2 bars mounted thereon, at least one portion, of each bar, that forms a surface of the die coater and comes in contact with the liquid coating composition is covered with a fluorine based resin, and when the covering process is conducted for the bar, a baking temperature is 100 to 380° C.

(Item 2)

In a coating apparatus comprising a pocket section for extending a liquid coating composition in the lateral direction of coating, a liquid coating composition supply inlet for supplying the liquid coating composition (coating liquid) to the pocket section, and a slit section for ejecting the liquid coating composition from the pocket section to an object to be coated, and employing a die coater having at least 2 bars mounted thereon, at least one portion, of each bar, that forms a surface of the die coater and comes in contact with the liquid coating composition is covered with a fluorine based resin, a preheating process is conducted for the bar at a temperature equal to or higher than the baking temperature for the fluorine based resin, a grinding process is conducted to remove deformation caused by the preheating process, and thereafter a covering process is conducted for the fluorine based resin with a baking temperature of 100 to 380° C.

(Item 3)

The coating apparatus described in Item 2, is characterized in that the above-mentioned grinding processing includes a finishing grinding process to make it into the last result form.

(Item 4)

The coating apparatus described in any one of Items 1 to 3, is characterized in that the straightness of the surface of the above-mentioned bar in the direction of coating width to which the covering process is carried out with fluorine based resin is 0.1 to 10 μm.

(Item 5)

The coating apparatus according to any one of items 1 to 4, is characterized in that the bars have a surface roughness of each portion subjected to the covering process within a range of 0.01 μm<Ra<1 μm and 0.1 μm<Rmax<5 μm.

(Item 6)

In a coating apparatus comprises a pocket section for extending a liquid coating composition in the lateral direction of coating, a liquid coating composition supply inlet-for supplying the liquid coating composition to the pocket section, and a slit section for ejecting the liquid coating composition from the pocket section to an object to be coated, and employing die coater having at least 2 bars mounted thereon, at least one portion, of each bar, that forms a surface of the die coater and comes in contact with the liquid coating composition is covered with a fluorine based resin, the straightness of the fluorine based resin covered portion of the bar in the lateral direction of coating is within a range from 0.1 to 10 μm.

(Item 7)

In a coating apparatus comprising a pocket section for extending a liquid coating composition in the lateral direction of coating, a liquid coating composition supply inlet for supplying the liquid coating composition to the pocket section, and a slit section for ejecting the liquid coating composition from the pocket section to an object to be coated, and employing a die coater having at least 2 bars mounted thereon, wherein at least one portion, of each bar, that forms a surface of the die coater and comes in contact with the liquid coating composition is covered with a fluorine based resin, and the surface roughness of the fluorine based resin covered portion of each is within a range of 0.01 μm<Ra<1 μm and 0.1μm<Rmax<5 μm.

(Item 8)

The coating apparatus according to any one of items 1 to 7, is characterized in that each portion of the bars to be covered with the fluorine based resin is removed in advance by grinding for the thickness of the fluorine based resin prior to the covering, and then covered with the fluorine based resin.

(Item 9)

The coating apparatus according to any one of items 1 to 8, is characterized in that after carrying out the covering process for the above-mentioned bar with a fluorine based resin, a finishing grinding processing is performed for it so that it may become the last result form.

(Item 10)

The coating apparatus according to any one of items 1 to 9, is characterized in that the die coater is comprised of at least two bars; the gap of at least one slit section formed by the bars has an outlet narrower than an inlet of a liquid coating composition and the gap d at the outlet is d ? 5×10-5 [m]; and the bars are components of a die coater that jets a liquid coating composition in a layer form from the slit section in order to make the liquid coating composition collide, at a predetermined gap, with an object to be coated for coating, the object being disposed or conveyed with no contact with the outlet of the slit section.

(Item 11)

The coating apparatus according to any one of items 1 to 9, is characterized in that the bars are structure members of an extrusion type die coater that extrudes the liquid coating composition from at least one slit section formed by at least 2 bars onto a belt-shaped support that is continuously conveyed from upstream to downstream, then forms beads of the liquid coating composition between the vicinity of a liquid coating composition extruding part of the lip section and the support, and coats the beads on the support.

(Item 12)

The coating apparatus according to any one of items 1 to 9, is characterized in that the bars are structure members of a slide type die coater that extrudes the liquid coating composition from at least one slit section formed by at least 2 of the bars onto a belt-shaped support that is continuously conveyed from upstream to downstream, lets the liquid coating composition having been extruded flow down along a steep which is continuous with the outlet of the slit, then forms beads of the liquid coating composition between the belt-shaped support and a vicinity of an end part of the steep, and coats the beads on the belt-shaped support.

(Item 13)

The coating apparatus according to any one of items 1 to 9, is characterized in that the bars are structure members of a curtain type die coater that lets the liquid coating composition having been extruded from at least one slit section formed by at least two of the bars fall freely onto a belt-shaped support that is continuously conveyed from upstream to downstream, and thereby coats the liquid coating composition.

(Item 14)

The coating apparatus according to any one of items 1 to 13, is characterized in that the bars are structure members of a die coater having a width of 1 meter or larger.

(Item 15)

The coating apparatus according to any one of items 9 to 14, is characterized in that the belt-shaped support is in a state that a surface opposite to a coated surface thereof is supported by a back roll.

(Item 16)

The coating apparatus according to item 11, is characterized in that the belt-shaped support is supported by a support roll at a position near the die coater.

(Item 17)

The coating apparatus, according to any one of items 1 to 16, is characterized in that the liquid coating composition is a liquid coating composition for a photosensitive layer containing a silver component for a heat-developing photosensitive material or a liquid coating composition for a non-photoreceptive protective layer.

(Item 18)

The coating apparatus, according to any one of items 1 to 15, is characterized in that a fluorine based resin which can be baked at 100 to 380° C. is used for the above-mentioned fluorine based resin.

(Item 19)

In a method of producing a die coater comprising a pocket section for extending a liquid coating composition in the lateral direction of coating, a liquid coating composition supply inlet for supplying the liquid coating composition to the pocket section, and a slit section for ejecting the liquid coating composition from the pocket section to an object to be coated, and constructed with at least 2 bars in which at least one portion, of each bar, that forms a surface of the die coater and comes in contact with the liquid coating composition is covered with a fluorine based resin, after a covering process is conducted for each portion of the bars to be covered with the fluorine based resin such that each portion is covered excessively than a thickness to be removed by a final grinding process, a baking process is conducted at a temperature of 100 to 380° C., thereafter the final grinding process is conducted to remove an excess portion of the fluorine based resin and to finish the surface of the fluorine based resin covered portion such that a straightness in a coating width direction is 0.1 to 10 μm and roughness is within a range of 0.01 μm<Ra<1 μm and 0.1 μm<Rmax<5 μm.

(Item 20)

In a method of producing a die coater comprising a pocket section for extending a liquid coating composition in the lateral direction of coating, a liquid coating composition supply inlet for supplying the liquid coating composition to the pocket section, and a slit section for ejecting the liquid coating composition from the pocket section to an object to be coated, and constructed with at 18 6668 least 2 bars in which at least one portion, of each bar, that forms a surface of the die coater and comes in contact with the liquid coating composition is covered with a fluorine based resin, a preheating process is conducted for the bars at a temperature equal to or higher than a baking temperature for the fluorine based resin, a first grinding process is conducted to remove deformation caused by the preheating so as to make the bar into a final shape, a second grinding process is conducted to remove a portion to be covered with the fluorine based resin in accordance with a thickness of the fluorine based resin, and after a covering process is conducted to cover excessively than a thickness removed by the second grinding process, a baking process is conducted at a temperature of 100 to 380° C., thereafter the final grinding process is conducted to remove an excess portion of the fluorine based resin and to finish the surface of the fluorine based resin covered portion such that a straightness in a coating width direction is 0.1 to 10 μm and roughness is within a range of 0.01 μm<Ra<1 μm and 0.1 μm<Rmax<5 μm.

(Item 21)

In a method of producing a die coater comprising a pocket section for extending a liquid coating composition in the lateral direction of coating, a liquid coating composition supply inlet for supplying the liquid coating composition to the pocket section, and a slit section for ejecting the liquid coating composition from the pocket section to an object to be coated, and constructed with at least 2 bars in which at least one portion, of each bar, that forms a surface of the die coater and comes in contact with the liquid coating composition is covered with a fluorine based resin, a preheating process is conducted for the bars at a temperature equal to or higher than a baking temperature for the fluorine based resin, a grinding process is conducted to remove deformation caused by the preheating, and after a covering process is conducted for each portion of the bars to be covered with the fluorine based resin such that each portion is covered excessively than a thickness to be removed by a final grinding process, a baking process is conducted at a temperature of 100 to 380° C., thereafter the final grinding process is conducted to remove an excess portion of the fluorine based resin and to finish the surface of the fluorine based resin covered portion such that a straightness in a coating width direction is 0.1 to 10 μm and roughness is within a range of 0.01 μm<Ra<1 μm and 0.1 μm<Rmax<5 μm.

As stated above, in the case where portions, of bars constructing a die coater, coming in contact with a liquid coating composition are covered with a fluorine based resin, the straightness of the abovementioned portions of the bars in the lateral direction of coating may not be maintained for a long time use.

The following factors can be considered as the causes. The internal stress which the bar which constitutes the die coater has by heat treatment when carrying out a covering process and the processing stress when producing a bar reveal, distortion occurs and the straightness of a die coater is worsened.

Furthermore, with aggravation of straightness, the slit clearance in the direction of coating width and the distance between the die coater and a coated matter become uneven, and the layer thickness uniformity in a coating width direction becomes worse.

As a result that inventors studied earnestly for these factors, the inventors found that a covering process heat treatment can be performed maintaining strength by performing covering process heat treatment with a fluorine based resin at the lowest possible temperature and by reinforcing the strength of the film of the fluorine based resin lost due to the lowered heat treatment temperature by using a thermosetting resin.

By the method of such combinations, at least two bars can be produced as follows.

A grinding process is conducted for the surface to which a covering process is carried out with fluorine based resin in such a way that it's straightness may become as small as possible, and surface roughness is finished so that it becomes within a predetermined range.

Since the die coater which is assembled and produced with at least two bars produced as mentioned above becomes usable, even if it is used for a long period of time, the layer thickness in a coating width direction is uniform, there may be little coating troubles, thereby coating ability can be improved.

There is provided a coating apparatus employing a die coater and a method of producing the die coater, wherein the die coater has a large width of 1 m or larger and is covered with a fluorine based resin at a portion coming in contact with a liquid coating composition, thereby making it possible to obtain coated products having a uniform coating layer thickness in the lateral direction of coating and few coating failures. Coating failures have decreased, layer thickness distribution has become stable, and accordingly, the product quality has become stable with an increase in the fine quality rate.

### BRIEF DESCRIPTION OF THE DRAWINGS

FIGS. 1a and 1b are schematic diagrams showing a slide coating system that performs coating by forming beads by the use of a slide type die coater.

FIGS. 2a and 2b are schematic diagrams of an extrusion coating system that uses an extrusion type die coater to form beads and perform coating.

FIG. 3 is a schematic diagram showing an extrusion coating system that performs coating of a support that is supported by a support roll, using an extrusion type die coater shown in FIGS. 2a and 2b.

FIGS. 4a and 4b are schematic diagrams of an extrusion coating system that uses another structure of extrusion type die coater and performs coating by colliding, across a predetermined gap from a slit section, a liquid coating composition with an object to be coated instead of forming beads.

FIG. 5 is a schematic diagram of a curtain coating system using the slide type die coater shown in FIGS. 1a and 1b.

FIG. 6 is a schematic flowchart showing a method of producing a die coater having bars mounted thereon, the bars being covered with a fluorine based resin.

FIG. 7 is a schematic flowchart showing a method of producing a die coater having bars mounted thereon, the bars having been subjected to a thermal pretreatment, thereafter to grinding, and then to fluorine based resin covering.

FIG. 8 is a schematic flowchart showing another method of producing a die coater having bars mounted thereon, the bars having been subjected to a thermal pretreatment, thereafter to grinding, and then to fluorine based resin covering.

### DETAILED DESCRIPTION OF THE PREFERRED EMBODIMENT

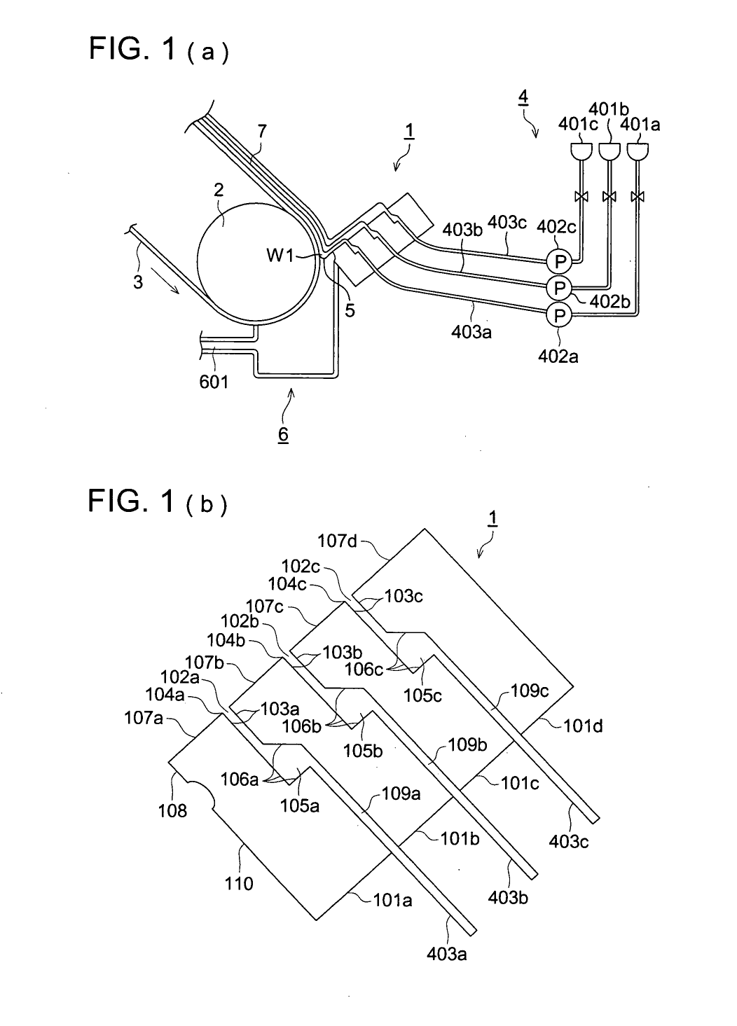

The best mode of the invention will be described referring to FIGS. 1a to 8, but the invention is not limited to this.

FIGS. 1a and 1b are schematic diagrams showing a slide coating system that performs coating by forming beads by the use of a slide type die coater.

FIG. 1a is a schematic diagram of the slide coating system that performs coating on a holding section of a support, which is held by a back-roll at a surface opposite to one to be coated, in such a way that the slide type die coater forms beads.

FIG. 1b is an enlarged schematic diagram showing the slide type die coater system shown in FIG. 1a.

In FIGS. 1a and 1b, numeral 1 represents the slide type die coater, 2 represents the back-roll, and 3 represents a belt-shaped support, which is continuously conveyed from upstream to downstream (in the direction shown by the arrow in the figure).

The slide type die coater 1 is produced mounting respective bars 101a to 101d thereon.

The quantity of bars is not fixed by the bars 101a to 101d, but can be increased or decreased depending on the quantity of layers to be coated.

The back-roll is a conveying roll disposed on the surface side of the belt-shaped support 3 opposite to the coating surface side thereof, sandwiching the belt-shaped support 3 cooperating with the slide type die coater 1.

Since the cylindricality of the back-roll has a significant effect on the accuracy of the gap in the lateral direction of coating as well as the slide type die coater 1, the back-roll is constructed of a metal with a large diameter of 200 mm or larger.

Numerals 102a to 102c represent slit sections that are arranged between the respective bars 101a to 101d which construct the slide type die coater and serving as an outlet of a liquid coating composition.

The quantity of slit sections is variable depending on the quantity of bars such as the respective bars 101a to 101d constructing a slide type die coater, and is ordinarily 2 to 20. The slide type die coater shown in FIGS. 1a and 1b is constructed by mounting 4 bars thereon, thus having 3 slit sections, and used for simultaneous multi-layer coating.

Numerals 103a to 103c represent the inner walls of the respective slit sections 102a to 102c, while numerals 104a to 104c represent edge sections at the outlets of the respective slit sections 102a to 102c.

Numerals 105a to 105c represent pocket sections formed at the respective slit sections 102a to 102c so that liquid coating compositions, the liquid coating compositions having been conveyed from respective supplying pipes 403a to 403c, are extruded from the respective slit sections 102a to 102c uniformly in the lateral direction.

Numerals 106a to 106c represent the inner walls of the pocket sections 105a to 105c.

Numerals 107a to 107d represent sliding surfaces. Liquid coating compositions adjusted by adjusting pots 401a to 401c of a liquid coating composition supply system 4 are fed to the respective liquid storing sections 105a to 105c formed between the bars 101a to 101d by liquid conveying pumps 402a to 402c through the respective supply pipes 403a to 403c, then the liquid coating compositions are ejected from the respective sections 102a to 102c, flow down along the respective sliding sections 107a to 107c, and form beads 5 through a lip section 108 to be coated on the holding section of the support 3 that is conveyed in such a way that the surface thereof on the side opposite to the surface to be coated is held by the back-roll 2.

Numeral 110 represents an outer wall that is continuous with the lip section 108. Numerals 109a to 109c represent liquid coating composition supply flow paths for supplying the liquid coating compositions, which have been conveyed from the respective pipes 403a to 403c, to the respective pocket sections 105a to 105c.

Numeral 6 represents a pressure reducing chamber for stabilizing coating, the pressure reducing chamber being arranged under the slide type die coater 1, wherein numeral 601 represents a suction pipe. Numeral 7 represents coating layers coated on the support 3. Symbol W1 represents a coating point where the slide type die coater 1 coats the liquid coating compositions on the support 3, wherein the coating point W1 is, in a typical case, preferably located at a position 0 to 20 degrees upward from the horizontal axis that goes through the back-roll.

When coating is performed for a long time, liquid coating compositions deposit on the lip section 108 and the outer wall 110 which is continuous with the lip section 108, become dry, and solidify. Further, foreign materials and silver halide grains mixed in the liquid coating compositions deposit on the respective inner walls 106a to 106c of the pocket sections 105a to 105c, on the respective inner walls 103a to 103c of the slit sections 102a to 102c, and on the respective edge sections 104a to 104c at the outlets of the slit sections 102a to 102c.

When deposits are pushed out by the liquid coating compositions and coated on the belt-shaped support as they are, foreign material deposition failures occur.

Also, when foreign materials and silver halide grains mixed in the liquid coating compositions deposit on the respective inner walls 103a to 103c of the slit sections 102a to 102c, the edge sections 104a to 104c, the sliding surfaces 107a to 107c, and the lip section 108, the flows of the liquid coating compositions at portions with the deposits are not normal and become streaks which cause streak failures. Further, when a covering film created by dried liquid coating compositions adheres to the lip section 108, beads forming becomes unstable, and accordingly, coating becomes unstable.

When coating films created by dried liquid coating compositions adhere to the outer wall 110 that is continuous with the lip section 108, cleaning after terminating coating becomes painstaking.

When adjusting the flow rates of liquid coating compositions or when cleaning the inside of the slit sections 102a to 102c prior to a start of coating, the liquid coating compositions flow down along the outer wall 110, and get dry and solidify.

Therefore, the outer wall 110 continuous with the lip section 108 needs cleaning such as rubbing off and scraping off such created solids for each coating.

Surfaces of the slide type die coater 1 shown in FIGS. 1a and 1b that contact a liquid coating composition according to the invention include the inner walls 103a to 103c of the slit sections 102a to 102c constructed of the respective bars 101a to 101d, the edge sections 104a to 104c, the inner walls 106a to 106c of the pocket sections 105a to 105c, the liquid coating composition supply flow paths 109a to 109c, the sliding sections 107a to 107c, the lip section 108, and the outer wall 110 continuous with the lip section 108.

These portions in contact with the liquid coating compositions are portions to be covered with a fluorine based resin according to the invention.

That is, in the slide type die coater 1 produced mounting the respective bars 101a to 101d thereon, portions, of the respective bars 101a to 101d, coming in contact with a liquid coating composition are the portions to be covered with a fluorine based resin according to the invention.

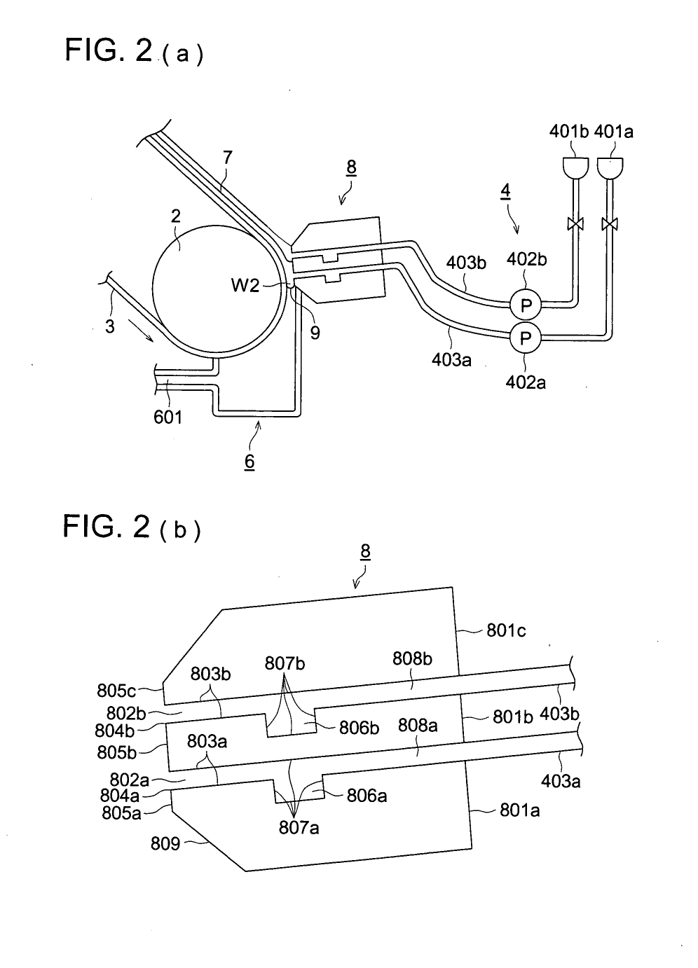

FIGS. 2(a) and 2(b) are schematic diagrams of an extrusion coating system that uses an extrusion type die coater to form beads and perform coating.

FIG. 2(a) is a schematic diagram of the extrusion coating system that uses the extrusion type die coater to form beads and perform coating of a holding section of a support, the support having a surface, opposite to one to be coated, held by a back-roll.

FIG. 2(b) is an enlarged schematic diagram of the extrusion type die coater shown in FIG. 2(a). Numeral 8 in FIGS. 2(a) and 2(b) represents the extrusion type die coater.

The extrusion type die coater 8 is produced mounting respective bars 801a to 801c thereon.

The quantity of bars is not fixed by the bars 801a to 801c, but can be increased or decreased depending on the quantity of coating layers.

Numerals 802a and 802b represent slit sections that are flow outlets of liquid coating compositions formed between the respective bars 801a to 801c that construct the extrusion type die coater 8.

The quantity of slit sections is variable depending on the quantity of bars such as the respective bars 801a to 801c constructing the extrusion type die coater, and typically in a range from 1 to 10.

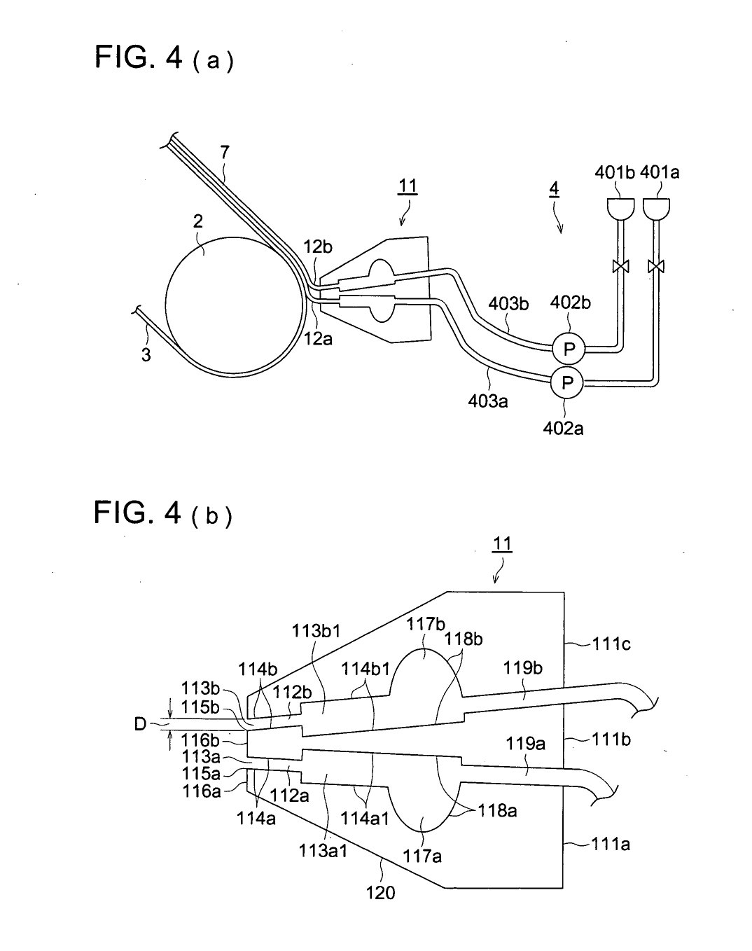

The extrusion type die coater shown in FIGS. 4a and 4b is constructed of 3 bars, having 2 slit sections for simultaneous multi-layer coating.

Numerals 803a and 803b represent inner walls of the respective slit sections 802a and 802b, numerals 804a and 804b represent edge sections at the outlets of the respective slit sections 802a and 802b, and numeral 805a to 805c represent lip sections.

Numerals 806a and 806b represent pocket sections formed at the respective slit sections 802a and 802b in order to push out the liquid coating compositions from the respective slit sections 802a and 802b uniformly in the lateral direction, the liquid coating compositions having been conveyed from the respective supplying pipes 403a and 403b.

Numerals 807a and 807b represent inner walls of the respective pocket sections 806a and 806b.

Numerals 808a and 808b represent liquid coating composition supply flow paths for supplying the liquid coating compositions, the liquid coating compositions having been conveyed from the respective supplying pipes 403a and 403b, to the respective pocket sections 806a and 806b.

Numeral 809 represents an outer wall continuous with the lip section 805a, and the outer wall 809 is a portion that needs cleaning, when adjusting the flow rates of liquid coating compositions or when cleaning the inside of the respective slit sections 802a and 802b prior to a start of coating, the liquid coating compositions flow down along the outer wall 809, and get dry and solidify, therefore, the outer wall 809 needs cleaning such as rubbing off and scraping off such created solids for each coating.

Surfaces, of the extrusion type die coater shown in FIGS. 2(a) and 2(b), that contact liquid coating compositions according to the invention include the respective inner walls 803a and 803b of the slit sections 802a and 802b, the respective edge sections 804a and 804b, the respective inner walls 807a and 807b of the pocket sections 806a and 806b, the liquid coating composition supply flow paths 808a and 808b, the lip sections 805a to 805c, and the outer wall 809 continuous with the lip section 805a.

These surfaces coming in contact with the liquid coating compositions are portions to be coated with a fluorine based resin.

Liquid coating compositions adjusted by adjusting pots 401a and 401b of a liquid coating composition supply system 4 are fed to the respective pocket sections 806a and 806b formed between the bars 801a to 801c through the respective supplying pipes 403a and 403b by respective solution conveying pumps 402a and 402b, then the liquid coating compositions are extruded from the respective slit sections 802a and 802b, pass through the lip section 805a, and form beads 9 to be coated on the holding section of the belt-shaped support 3 that is conveyed in such a way that the surface thereof on the side opposite to the surface to be coated is held by the back-roll 2.

Symbol W2 represents a coating point where the coater 8 coats the support 3 with the liquid coating compositions, wherein the coating point W2 is, in an ordinary case, preferably located at a position 0 to 90 degrees downward from the horizontal axis that goes through the back-roll. Other symbols represent the same as those in FIGS. 1a and 1b.

When coating is performed for a long time, liquid coating compositions deposit on the lip section 805a and the outer wall 809 which is continuous with the lip section 805a, become dry and solidify, further, foreign materials and silver halide grains mixed in the liquid coating compositions deposit on the respective inner walls 807a and 807b of the pocket sections 806a and 806b, the respective edge sections 804a and 804b, and the respective inner walls 803a and 803b of the slit sections 802a and 802b.

When deposits are pushed out by the liquid coating compositions and coated on the belt-shaped support as they are, foreign material deposition failures occur.

Also, when foreign materials and silver halide grains mixed in the liquid coating compositions deposit on the respective inner walls 803a and 803b of the slit sections 802a and 802b, the respective edge sections 804a and 804b, and the lip sections 805a to 805c, the flows of the liquid coating compositions at the portions with deposits become different and turn into streaks which cause streak failures.

Further, when a covering film created by a dried liquid coating composition adheres to the lip section 805a, beads forming becomes unstable, and accordingly, coating becomes unstable.

When a covering film created by a dried liquid coating composition adheres to the outer wall 809 that is continuous with the lip section 805a, cleaning after terminating coating becomes painstaking.

Surfaces, of the extrusion type die coater shown in FIGS. 2(a) and 2(b), that contact liquid coating compositions include the respective inner walls 803a and 803b of the slit sections 802a and 802b, the respective edge sections 804a and 804b, the respective inner walls 807a and 807b of the pocket sections 806a and 806b, the liquid coating composition supply flow paths 808a and 808b, the lip sections 805a to 805c, and the outer wall 809 continuous with the lip section 805a.

These surfaces in contact with the liquid coating compositions are portions to be covered with a fluorine based resin according to the invention.

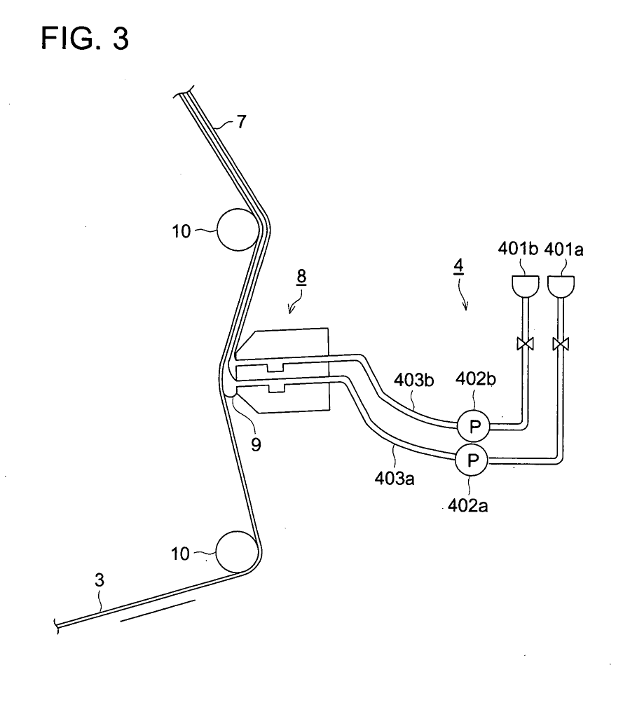

That is, in the extrusion type die coater 8 produced mounting the respective bars 801a to 801d thereon, portions, of the respective bars 801a to 801d, coming in contact with a liquid coating composition are the portions to be covered with a fluorine based resin according to the invention. FIG. 3 is a schematic diagram showing an extrusion coating system that performs coating of a support that is supported by a support roll, using an extrusion type die coater shown in FIGS. 2(a) and 2(b).

Numeral 10 in the figure represents the support roll. Other symbols represent the same as those in FIGS. 2a and 2b.

Numeral 10 in the figure represents the support roll. Other symbols represent the same as those in FIGS. 2a and 2b. The only difference between the coating system shown in FIG. 3 and the coating system shown in FIGS. 2a and 2b is that the coating system uses a different method of supporting of the belt-shaped support from one shown in FIG. 2a, therefore, portions where liquid coating compositions deposit through a long time coating, portions where foreign materials adhere, surfaces in contact with the liquid coating compositions, and portions to be coated with a fluorine based resin are the same as those of the extrusion type die coater shown in FIGS. 2a and 2b.

FIGS. 4a and 4b are schematic diagrams of an extrusion coating system that uses another structure of extrusion type die coater and performs coating by colliding, across a predetermined gap from a slit section, a liquid coating composition with an object to be coated instead of forming beads.

FIG. 4(a) is a schematic diagram of the extrusion coating system that performs coating on a holding section of a support having a surface, opposite to a surface to be coated, held by a back roll, using another structure of extrusion type die coater without forming beads.

FIG. 4(b) is an enlarged schematic diagram of the extrusion type die coater shown in FIG. 4(a).

In FIGS. 4a and 4b, numeral 11 represents the extrusion type die coater.

The extrusion type die coater 11 is produced having bars 111a to 111c mounted thereon.

The quantity of bars is not fixed by the bars 111a to 111c, but can be increased or decreased depending on the quantity of coating layers.

Numerals 112a and 112b represent slit sections arranged between the respective bars 111a to 111c which construct the extrusion type die coater.

Numerals 12a and 12b represent coating layers formed by ejecting liquid coating compositions from the respective slit sections 112a and 112b.

The quantity of slit sections is variable depending on the quantity of bars constructing the extrusion type die coater, and is typically in a range from 1 to 10.

The extrusion type die coater shown in FIGS. 4a and 4b is constructed of 3 bars, having 2 slit sections for simultaneous multi-layer coating.

Numerals 113a and 113b represent the outlet sides, of liquid coating compositions, of the respective slit sections 112a and 112b, and numerals 113a1 and 113b1 represent the inlet sides of, of the liquid coating compositions, of the respective slit sections 112a and 112b.

Numerals 114a and 114b represent inner walls of the respective slit sections 112a and 112b on the respective outlet sides 113a and 113b of the liquid coating compositions, and numerals 114a1 and 114b1 represent inner walls of the respective slit sections 112a and 112b on the respective inlet sides 113a1 and 113b1 of the liquid coating compositions.

Numerals 115a and 115b represent edge sections of the respective slit sections 112a and 112b, and numerals 116a and 116b represent lip sections.

Numerals 117a and 117b represent liquid storing sections formed at the respective slit sections 112a and 112b to extrude the liquid coating compositions, the liquid coating compositions having been conveyed from the respective supply pipes 403a and 403b, out from the respective slit sections 112a and 112b uniformly in the lateral direction.

Numerals 118a and 118b represent inner walls of the respective liquid storing sections 117a and 117b.

Numerals 119a and 119b represent liquid coating composition supply flow paths for supplying the liquid coating compositions, the liquid coating compositions having been conveyed from the respective supplying pipes 403a and 403b, to the respective liquid storing sections 117a and 117b.

Numeral 120 represents an outer wall continuous with the lip section 116a. The outer wall 120 is a portion that needs cleaning, specifically, when adjusting the flow rates of liquid coating compositions or when cleaning the inside of the respective slit sections 112a and 112b prior to a start of coating, the liquid coating compositions flow down along the outer wall 120, and get dry and solidify. Therefore, the outer wall 120 needs cleaning such as rubbing off and scraping off such created solids for each coating.

Surfaces, of the extrusion type die coater shown in FIGS. 4a and 4b, that contact with liquid coating compositions include the respective inner walls 114a and 114b of the slit sections 112a and 112b on the outlet side 113a and 113b of the liquid coating compositions, the respective inner walls 114a1 and 114b1 of the slit sections 112a and 112b on the inlet side 113a1 and 113b1 of the liquid coating compositions, the edge sections 115a and 115b, the respective lip sections 116a and 116b, the respective inner walls 118a and 118b of the liquid storing sections 117a and 117b, the respective liquid coating composition supplying flow paths 119a and 119b, and the outer wall 120 continuous with the lip section 116a.

These surfaces coming in contact with the liquid coating compositions are portions to be coated with a fluorine based resin.

That is, in the extrusion type die coater 11 produced having the respective bars 101a to 101c mounted thereon, portions of the respective bars 111a to 111c coming in contact with a liquid coating composition are the portions to be covered with a fluorine based resin according to the invention.

The liquid coating compositions adjusted by adjusting pots 401a and 401b of a liquid coating composition supply system 4 are supplied to the respective liquid storing sections 117a and 117b arranged between the respective bars 111a to 111c through the respective supply pipes 403a and 403b by liquid conveying pumps 402a and 402b, then the liquid coating compositions are ejected from the respective slit sections 112a and 112b in a layer form so that the liquid coating compositions are collided with the holding section of the belt-shaped support 3 that is conveyed in such a way that the surface thereof on the side opposite to the surface to be coated is held by the back-roll 2, and thus the liquid coating compositions are coated on the holding section of the belt-shaped support 3.

Symbol D represents an outlet gap of a slit section.

The outlet gap D can be properly adjusted depending on the physical properties of a liquid coating composition to be used and the thickness of a coating layer.

The gap of the slit section is wider on the inlet side of the liquid coating composition and narrower on the outlet side, wherein the outlet gap D of the slit section is in a range of D≦5×10⁻⁵ [m]. More preferably, D is in a range of 1×10⁻⁵ [m]≦D≦4×10⁻⁵ [m].

The outlet gap D is set in such a range so that the liquid coating composition is ejected in an extremely thin layer form that allows thin layer coating compared with known extrusion type die coaters.

In the case of the extrusion type die coater shown in FIGS. 4a and 4b, portions where foreign materials and silver halide grains deposit in the course of coating for a long time are the same as those of the extrusion type die coater shown in FIGS. 2a and 2b.

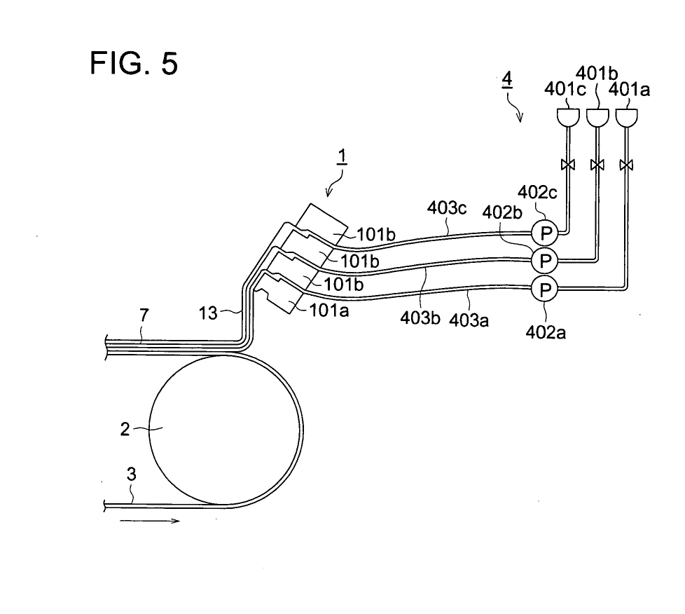

FIG. 5 is a schematic diagram of a curtain coating system using the slide type die coater shown in FIGS. 1a and 1b.

In FIG. 5, numeral 13 represents layers formed in such a way that liquid coating compositions extruded out from the outlets of respective slit sections flow down along a sliding surface in a state the liquid coating compositions are laminated and fall with gravity.

The layers 13 are coated on a belt-shaped support. Other symbols represent the same as those in FIGS. 1a and 1b.

In the case of the slide type die coater shown in FIG. 5, surfaces in contact with liquid coating compositions, portions subjected to covering with a fluorine based resin, and portions where foreign materials and silver halide grains deposit through coating for a long time, are the same as those of the slide type die coater shown in FIGS. 1a and 1b. In the invention, the slide type die coater, the curtain type die coater and the extrusion type die coaters shown in FIGS. 1a to 5 are also referred to as a die coater to be a generic term.

In the various types of die coaters shown in FIGS. 1a to 5, a pocket section is usually designed in a large cross section for a low flow velocity so that a liquid coating composition is distributed in a uniform pressure in the lateral direction of coating.

In general, foreign materials and silver halide grains in a liquid coating composition easily deposits on a surface of a die coater. Once they have deposited, the depositions turn into a core and grow, and then get torn by some shock to be mixed in the liquid coating composition, causing a coating failure, therefore, covering with a fluorine based resin to prevent deposition is effective in preventing occurrence of coating failures.

Since a slit section has a narrow gap and the flow velocity of a coating liquid is fast, it may be considered that it may be more difficult for foreign materials and silver halide grains to adhere to the slit than the pocket section. However, if foreign materials and silver halide grains in the liquid coating composition deposit on a surface even a little, the flow path is blocked to cause a streak-shape failure, therefore, performing coating with fluorine based resin to avoid deposition is effective in preventing occurrence of coating failure.

When the straightness of a slit section is low, it is difficult to eject a liquid coating composition in the lateral direction of a die coater with a uniform pressure, thus the ejection amount of the liquid coating composition is unstable in the lateral direction, and the coating layer thickness in the lateral direction is not constant, therefore, making the straightness small is effective in achieving a constant coating layer thickness in the lateral direction.

To prevent deposition of foreign materials and silver halide grains in a liquid coating composition on a lip section, it is quite effective to cover the lip section with a fluorine based resin as well as in the case of a slit section.

Particularly at a lip section, which is on the lowest downstream side, when a liquid coating composition having come round beads and deposited gets dry and solidifies, beads cannot be formed stably, and accordingly, stable coating is not allowed, therefore, it is extremely effective to cover with a fluorine based resin in preventing deposition to avoid coating failures.

If the straightness of a lip section is low, forming of beads is unstable in the lateral direction, and it is impossible to perform stable coating, by which the coating layer thickness in the lateral direction is not constant, therefore, it is effective to make the straightness small in achieving a constant coating layer thickness in the lateral direction.

Since a liquid coating composition on a sliding surface flows down with gravity, the flow velocity is small, by which foreign materials and silver halide grains in the liquid coating composition tend to deposit as well as in a pocket section. Therefore, it is extremely effective to cover a fluorine based resin in preventing deposition to avoid coating failures.

When the straightness of a sliding surface is low, a liquid coating composition flows down on the sliding surface unstably, and it is impossible to perform stable coating, by which the coating layer thickness in the lateral direction is not constant.

Therefore, it is effective to make the straightness small in achieving a constant coating layer thickness in the lateral direction.

An edge is also a part where foreign materials and silver halide grains in a liquid coating composition tend to deposit, and deposition, when occurred, makes a flow of the liquid coating composition unstable to cause a streak failure.

Therefore, it is effective to cover with a fluorine based resin in preventing deposition to avoid coating failures.

When the straightness of an edge is low, the ejection amount of a liquid coating composition is unstable in the lateral direction of a slit, and it is impossible to perform stable coating, by which the coating layer thickness in the lateral direction is not constant. Therefore, it is effective to make the straightness small in achieving a constant coating layer thickness in the lateral direction.

When adjusting the flow rates of liquid coating compositions or when cleaning the inside of respective slit sections prior to a start of coating, the liquid coating compositions flow down along an outer wall that is continuous with a lip section, deposit, and get dry and solidify, which requires cleaning such as rubbing off and scraping off for each coating. Thus, the outer wall continuous with the lip section is a part which takes time to be cleaned. It is effective to cover a fluorine based resin on the outer wall continuous with the lip section in greatly reducing deposition of liquid coating compositions, which shorten the time for cleaning.

In the case of coating by a die coater that is produced with the bars having been subjected to covering with a fluorine based resin at portions thereof coming in contact with a liquid coating composition for a long time, the portions of the die coater in contact with a liquid coating composition have less dirt, but, in the case that it is used for a long time, coating with a uniform coating layer thickness in the lateral direction of coating may not be achieved, which particularly tends to occur on a die coater having a large coating width not smaller than 1 m. The inventors found out the following after their earnest studies.

When conducting covering process on the portion where a coating solution comes in contact with a bar by using a fluorine based resin, there are performed heat treatment for cleaning the surface to be processed and heat treatment called a baking treatment for making fluorine to adhere to the base material.

In the past, conventional temperatures for the baking treatment after coating a fluorine based resin have been 400 to 500° C. usually. However, these temperatures cause the following problems.

1) Strains which are caused when a bar is processed and still remain after the removing operation and strains caused by the processing stress become obvious and deteriorate the straightness of the bar.

The grinding process is conducted for correcting the strains which have become obvious, which results in the state wherein the processing stress remains on the bar.

In the die coater that is made by incorporating therein the bar which is in the aforesaid condition, strains of the bar become getting more and more obvious while the die coater is used for a long time, the straightness of the die coater is deteriorated, and a slit clearance and a distance between the die coater and an object to be coated both in the direction perpendicular to the coating direction become uneven, resulting in deterioration of uniformity of the layer thickness in the direction perpendicular to the coating direction.

2) A thickness of covering with a fluorine based resin needs to be greater than a thickness for grinding that is necessary for correcting strains after the baking treatment, which results in a cost increase.

The invention relates to a coating apparatus employing a die coater made by incorporating therein at least two bars each having constant straightness wherein fluorine based resin is coated to cover at least a part of each of the two bars corresponding respectively to a pocket section that is a portion to come into contact with a coating solution and expands a coating solution in the direction perpendicular to the coating direction and to an outer wall that connects to a coating solution supply inlet through which a coating solution is supplied to the pocket section and to a slit section and a lip section through which a coating solution is jetted from the pocket section to the object to be coated, and relates to a method of making the die coater.

In the invention, a covering process heat treatment is referred to, including a heat treatment for cleaning surfaces, to be covered, in the covering process with a fluorine based resin and a baking treatment.

For lessening the strains caused by a baking process for fluorine based resin as far as possible, it is necessary, as the first means, to control the temperature for the baking treatment to be as low as possible, while maintaining the necessary layer thickness of fluorine based resin and the property of adhesion to the bar.

As a means to compensate for the layer strength of the fluorine based resin lost by lowering the temperature for the baking treatment, it has been found that a method to disperse fluorine based resin in thermosetting resin and to use them as a paint is effective.

As a fluorine based resin according to this invention, those generally used can be used. The fluorine based resin is not limited to a specific one. For example, a polytetrafluoroethylene (PTFE), a tetrafluoroethylene-perfluoroalkylvinylether copolymer (PFA), a tetrafluoroethylene-hexafluoropropylene copolymer (FEP), an ethylene-tetrafluoroethylene copolymer (tetrafluoroethylene-ethylene copolymer), a polychlorotrifluoro ethylene copolymer (PCTFE), a chlorotrifluoroethylene-ethylene copolymer (ECTFE), a PVF (PVF), a polyvinylidene fluoride (PVDF), etc. may be usable.

Especially, among these fluorine based resin, FEP, ETFE, and ECTFE are excellent in solvent resistance, scratching-resistance, and wear and abrasion resistance, and, moreover, can be baked at low temperature rather than other fluorine based resin. Therefore, the above-mentioned resins are employed as a desirable fluorine based resin for the coating to the die applicator according to this invention.

As a thermosetting resin, for example, a phenol resin (PF), a urea resin (UF), a melamine resin (MF), an epoxy resin (EP), a unsaturated polyester resin (UP), a diallylphthalate resin (PDAP), a polyimide resin (PI), polyamide-imide resin (PAI), a silicone resin (SI), etc. may be listed. As a desirable thermosetting resin, PAI may be listeded especially.

It became possible to make a temperature of a baking process low by using such a thermosetting resin. The temperature for baking treatment after coating fluorine based resin is 100-380° C. When the temperature for baking treatment is less than 100° C., the strength of a layer of a fluorine based resin is not obtained and the layer comes off during coating, which sometimes causes troubles and is not preferable. When the temperature for the baking process exceeds 380° C., strains caused on the bar become large, an amount of grinding for finish grinding becomes large, and processing stress resulting from grinding remains on the bar, thus, in the die coater made by incorporating therein these bars, the strains of the bar become obvious when the die coater is used for a long time, and necessary straightness cannot be obtained, and coated layer thickness is not stabilized, which is not preferable. Further, when grinding the surface covered by fluorine based resin, it sometimes happens that a fluorine based resin cover is ground off before bending and torsion caused by strains of the bar are removed. Therefore, the fluorine based resin cover needs to be thicker, resulting in cost increase, depending on a type of the fluorine based resin, which is not preferable.

In the method to use fluorine based resin capable for low temperature baking and to use fluorine based resin as a paint wherein fluorine based resin is dispersed in thermosetting resin, it has become possible to make the temperature for baking treatment to be 100-380° C. and thereby to prevent strains caused by baking treatment. By preventing strains, it has become possible to thin a layer thickness of fluorine based resin and thereby to control cost increase.

The temperature for heat treatment in the case of cleaning the surface of the bar with fluorine based resin conducted as preliminary process for covering process with fluorine based resin is the same as or lower than the temperature for baking treatment for the layer of fluorine based resin.

By performing the baking process at 100 to 380° C. when a bar is covered with a fluorine based resin, removing the caused deformation, thereafter coating with the bar with fluorine based resin, and deformation of the bar caused by the baking treatment can be reduced, even if the die coater has a large width not smaller than 1 m for which reduction of deformation has been difficult before.

Particularly, a bar for a die coater with a large width ranging from 1 to 4 m is preferably suitable.

As a second means, preliminary heat treatment is conducted at the temperature that is the same as or higher than the baking treatment temperature of fluorine based resin in advance before covering process of fluorine based resin, then, finishing grinding process for correcting strains caused and for making a shape of a final finish, and covering process of fluorine based resin at 100-380° C. is conducted as the baking treatment.

Internal stress owned by a bar constituting a die coater and processing stress caused in the course of making a bar are made to become obvious by conducting preliminary heat treatment, so that strains are caused, and after removing the strains by grinding processing, covering process of fluorine based resin is conducted, thus, it has become possible to control occurrence of strains at the baking treatment temperature of fluorine based resin.

The grinding process of forming the final finished shape means a grinding process for forming the shape of a bar in a design drawing.

In the case of the die coater for which the dimensional accuracy with a unit of a micrometer is required, it happens frequently that grinding process is repeated many times in the pursuit of the accuracy for finish grinding. Therefore, a thickness to be removed by grinding exceeds a thickness of a layer of fluorine based resin in many cases.

Therefore, by conducting finishing grinding process in advance, it is possible to conduct grinding process so that a desired form may be obtained, without removing an amount equivalent to the thickness of fluorine based resin by grinding process after covering process.

In the case of the bar that is subjected to preliminary heat treatment at the temperature lower than that for the baking treatment, strains generated on the bar by the baking treatment conducted after the covering process of fluorine based resin grows greater, and thereby, an amount of grinding for correcting the generated strains is increased, resulting in the state where the processing stress caused in the course of removing the strains remains on the bar.

When the die coater is made by incorporating therein the bar that is under the aforesaid condition, strains of the bar become getting more and more obvious while the die coater is used for a long time, the straightness of the die coater is deteriorated, and a slit clearance and a distance between the die coater and an object to be coated both in the direction perpendicular to the coating direction become uneven, which sometimes results in deterioration of uniformity of the layer thickness in the direction perpendicular to the coating direction, and is not preferable.

It is difficult to determine the upper limit of the temperature of the thermal pretreatment because it varies with the material to be employed for the bar, but at least, it should be lower than the melting point of the material.

By performing the thermal pretreatment on the bar in advance and by conducting a covering process with a fluorine based resin at a temperature of 100 to 380° C. in the baking process, then deformation of the bar caused by the baking treatment can be reduced, even if the die coater has a large width not smaller than 1 m for which reduction of deformation has been difficult before. Particularly, a bar for a die coater with a large width ranging from 1 to 4 m is preferably suitable.

It has become possible to make the bar that is further excellent in terms of straightness by applying the covering process treatment by fluorine based resin on the bar through the second means, and a coating apparatus employing the die coater made by incorporating at least two bars of this kind has made it possible to obtain a coated product which has a uniform thickness of a coated layer in the direction perpendicular to the coating direction in spite of the use for a long time, and has less coating troubles.

In the third means, preliminary heat treatment is conducted in advance at the temperature equal to or higher than that for baking treatment of fluorine based resin, before the covering process of fluorine based resin, then, a portion to be subjected to covering process with fluorine based resin is ground in advance to match the thickness of fluorine based resin, after the generated strain is corrected, and covering process of fluorine based resin wherein a temperature for baking treatment is 100-380° C. is conducted.

In addition to the effect by the first and second means, the third means is an effective means by grinding-removing the material, in advance prior to covering, at portions to be covered with a fluorine based resin, for the thickness of the fluorine based resin, and thereafter covering the grinded portions with the fluorine based resin to be thick, even if the covered surface is grinded, it is allowed to obtain a uniform surface having an excellent straightness without causing a step between a portion which is not covered and a portion which is covered, and further, retention of a liquid coating composition and deposition of foreign materials are prevented.

By conducting the covering process on the bar with fluorine based resin through the third means, it has become possible to make the bar that is further excellent in terms of straightness, in addition to the effects of the first means and the second means, and a coating apparatus employing the die coater made by incorporating at least two bars of this kind has made it possible to obtain a coated product which has a uniform thickness of a coated layer in the direction perpendicular to the coating direction in spite of the use for a long time, and has less coating troubles.

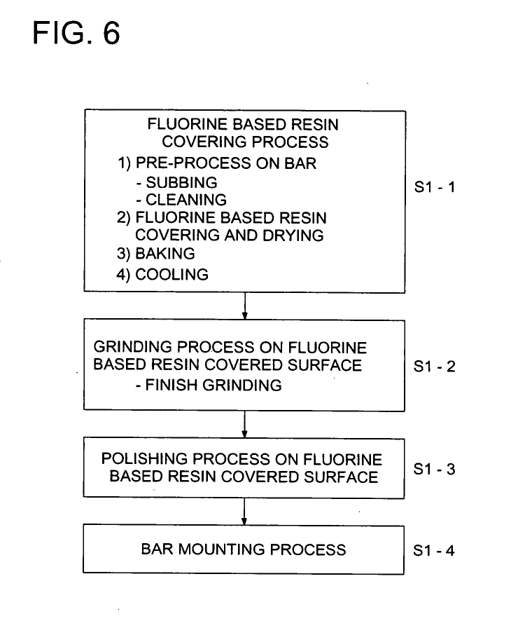

A method of producing a die coater according to the invention will be described referring to FIGS. 6 to 8.

FIG. 6 is a schematic flowchart showing a method of producing a die coater having bars mounted thereon, the bars being covered with a fluorine based resin.

Producing a die coater covered with a fluorine based resin at portions coming in contact with a liquid coating composition can be divided into a fluorine based resin covering process S1-1, a grinding process S1-2 of grinding surfaces covered with the fluorine based resin, a polishing process S1-3 of polishing the surfaces covered with the fluorine based resin, and a mounting process S1-4 of mounting bars.

Each process will be described below.

The fluorine based resin covering process S1-1 comprises 1) a pre-treatment process of a bar, 2) a covering and drying process, 3) a baking process, and 4) a cooling process.

The pre-treatment process of a bar includes 1) a foundation treatment process that makes the fluorine based resin covering surfaces of the bar rough by sandblast or the like prior to fluorine based resin covering in order to give excellent adherability and prevent peeling after the fluorine based resin covering, and 2) a sweeping treatment and a heat treatment (burning process) for cleaning of the surfaces to be covered with the fluorine based resin.

It is necessary that the temperature of the heat treatment (burning process) for cleaning is the same as or lower than that for the baking treatment.

If the temperature is higher than that for the baking treatment, it is possible that a greater deformation is caused than that caused by the baking treatment, by which the grinding amount for removing deformation increases and a grinding stress remains in the bar.

The covering/drying process with a fluorine based resin is a process that performs covering a bar having been subjected to pre-process with the fluorine based resin by painting, immersion, etc. and performs drying.

The baking process is a process for sticking the fluorine based resin to the die coater.

The temperature of the baking process in the fluorine based resin covering process is 100 to 300° C. By lowering the temperature for the baking treatment to 100-380° C., it is possible to control that the processing stress which is generated when the bar is made and still remains on the bar becomes obvious.

With respect to the thickness of fluorine based resin layer in the case of covering process with fluorine based resin, finish grinding with less amount of grinding is possible after the covering with fluorine based resin, because strains are hardly generated in the baking treatment when the temperature for the baking treatment with fluorine based resin is lowered to 100-380° C., and thereby, the processing stress that is caused by grinding and remains in the bar can be controlled to be low.

Further, it is possible to make a thickness of the fluorine based resin in the covering process thinner such as 0.1 mm or less.

However, in the case where the fluorine based resin cover is thinner than 0.03 mm, the fluorine based resin cover may be lost by grinding the surface of the fluorine based resin cover, which requires careful attention to be prevented.

On the other hand, although the covering film thickness may be greater than 0.1 mm, then the covering film tends to be thicker than required, causing a higher cost depending on the type of the fluorine based resin.

The cooling process cools the bar after the baking.

The finish grinding process S1-2, of the surfaces covered with the fluorine based resin, grinds and corrects the deformation caused by the baking treatment performed after the fluorine based resin covering, and finishes the straightness of the surfaces of the bar in the lateral direction of coating to a required straightness.

The straightness of a surface of a die coater according to the invention ranges from 0.5 to 10 μm (per meter) in the lateral direction of coating.

By making the straightness of surfaces in the lateral direction of coating within a range from 0.1 to 10 μm, a uniform coating layer is achieved.

If the straightness is smaller than 0.1 μm, machining is difficult due to the limit on the grinding accuracy. If the straightness is greater than 10 μm, it is not preferable because the coating layer thickness becomes unstable.

In the invention, strains generated in baking treatment are lessened because the fluorine based resin for which the working temperature for the baking treatment is as low as 100-380° C. is used, and therefore, an amount of grinding in grinding process for finishing can be small, which has made it possible to lessen the processing stress remaining in the bar.

The process of grinding the surface covered by fluorine based resin in S1-3 means the grinding process in which the surface processed with fluorine based resin is made to have a certain surface roughness.

The grinding process means the process to create a certain surface roughness, because of the fear that an influence of the surface roughened by a sand blast as preliminary processing before covering processing by fluorine based resin may remain to become coating defects.

A polishing machine may be used for polishing, and manual polishing using polishing powder is also allowed. The surface roughness of the portion covered with fluorine based resin related to the invention is expressed by 0.01 μm<Ra<1 μm and 0.1 μm<Rmax<5 μm.

By attaining such a surface roughness, foreign materials and silver halide grains in a liquid coating composition are prevented from depositing and the flow of the liquid coating composition is made smooth even for a long time coating, thus preventing coating failure and stably obtaining uniform coating layers.

In the case where the surface roughness Ra is smaller than 0.01 μm, machining is difficult, and the straightness at the portions covered with the fluorine based resin may be deteriorated, which is not preferable.

If the the surface roughness is greater than 1 μm, it is not preferable because the flow of the coating liquid becomes no good and the coating becomes unstable. In the case where the surface roughness Rmax is smaller than 0.1 μm, machining is difficult, and the straightness at the portions covered with the fluorine based resin may be deteriorated, which is not preferable.

If the surface roughness is greater than 5 μm, it is not preferable because the flow of the coating liquid becomes no good and the coating becomes unstable. The bar mounting process S1-4 mounts at least 2 bars having been subjected to the polishing process S1-3 and produces a die coater.

It is possible to produce a die coater, according to the invention, that is covered with a fluorine based resin at portions coming in contact with a liquid coating composition through the processes S1-1 to S1-4.

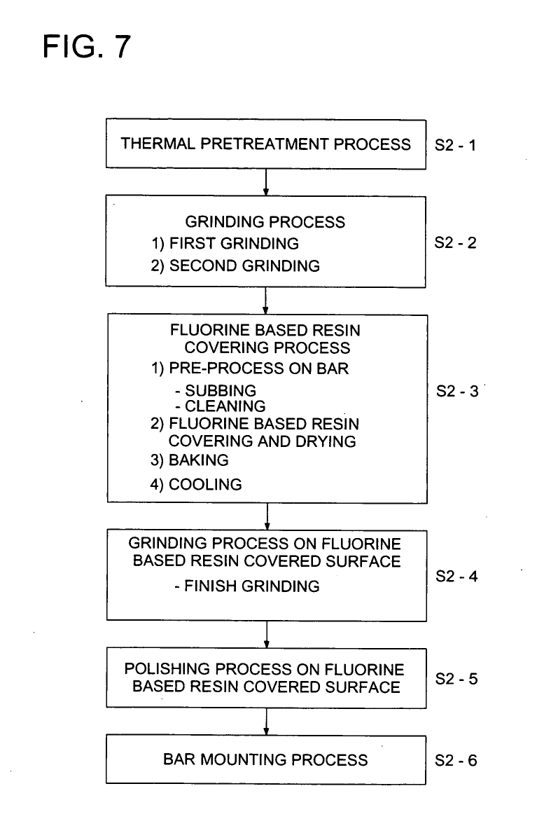

FIG. 7 is a schematic flowchart showing a method of producing a die coater having bars mounted thereon, the bars having been subjected to a thermal pretreatment, thereafter to grinding, and then to fluorine based resin covering.

Producing of a die coater covered with a fluorine based resin at portions coming in contact with a liquid coating composition can be divided into the processes, namely, a thermal pretreatment process S2-1 on a bar, a grinding process S2-2, a fluorine based resin covering process S2-3, a grinding process S2-4 on the surfaces covered with the fluorine based resin, a polishing process S2-5 on the surfaces covered with the fluorine based resin, and a bar mounting process S2-6. Each process will be described below.

The thermal pretreatment process S2-1 on a bar is executed prior to the heat treatment (baking process) of a fluorine based resin covering process, and performs heat treatment at a temperature same as or higher than that of the baking process of the fluorine based resin to elicit deformation generated by an inner stress or a machining stress which are caused through producing the bar, thereby reducing the deformation caused by the heat treatment of the fluorine based resin covering process.

It is difficult to determine the upper limit of the temperature of the thermal pretreatment because it varies with a material to be employed for the bar, but at least, it should be lower than the melting point of the material.

By performing the thermal pretreatment, the deformation of the bar caused by the baking process can be reduced.

The grinding process S2-2 includes 1) a grinding process for correction of deformation accompanying the elicitation of the inner stress caused in the thermal pretreatment process S2-1 on the bar and the machining stress generated through producing the bar and 2) a grinding process of forming a final shape.

Residual stress is made small by correcting strains of the bar generated in the course of preliminary heat treatment process, and the preheat treatment is conducted at the temperature equal to or higher than that for baking treatment with fluorine based resin, thus, occurrence of strains of the bar in the course of heat treatment of the process of covering processing of fluorine based resin can be controlled. By conducting grinding process for finish to obtain a final form, the final grinding after the covering process is easy.

In the following, the grinding process S2-4 on the surfaces covered with the fluorine based resin, the polishing process S2-5 on the surfaces covered with the fluorine based resin, and the bar mounting process S2-6 are the same as the processes S2-2 to S2-4 shown in FIG. 6.

It is possible to produce a die coater, according to the invention, that is covered with a fluorine based resin at portions coming in contact with a liquid coating composition through the processes S2-1 to S2-6.

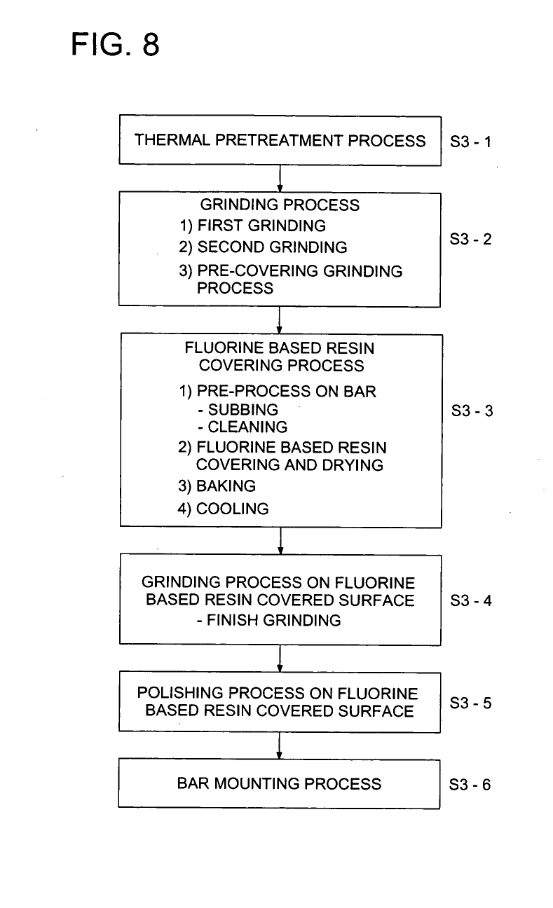

FIG. 8 is a schematic flowchart showing another method of producing a die coater having bars mounted thereon, the bars having been subjected to a thermal pretreatment, thereafter to grinding, and then to fluorine based resin covering.

In the method of producing a die coater shown in FIG. 8, a second grinding process for removing the material for the thickness of a fluorine based resin is added to the grinding process S2-2 of the method shown in FIG. 7.

By grinding-removing the material in the second grinding process, in advance prior to covering, at portions to be covered with a fluorine based resin, for the thickness of the fluorine based resin, and thereafter covering the grinded portions with the fluorine based resin to be thick, even if the covered surface is grinded, it is allowed to obtain a uniform surface having an excellent straightness without causing a step between a portion which is not covered and a portion which is covered, and further, retention of a liquid coating composition and deposition of foreign materials are prevented, which is an effective means. The rest of S3-1 to S3-6 are the same as those in FIG. 7.

It is possible to produce a die coater, according to the invention, that is covered with a fluorine based resin at portions coming in contact with a liquid coating composition through the processes S3-1 to S3-6.

By the method of producing a die coater, shown in FIGS. 6 to 8, according to the invention, various die coaters, shown in FIGS. 1 to 5, that perform wide web coating in a coating width ranging from 1 to 4 m have advantages including 1) reducing deformation that accompanies fluorine based resin covering, 2) enabling fluorine based resin covering of the portions, of the die coater, coming into contact with a liquid coating composition with accuracy.

It has become possible to obtain a coating apparatus employing a die coater wherein uniformity of the slit clearance in the direction perpendicular to the coating direction and of a distance between the die coater and an object to be coated can be maintained, foreign substances in a coating solution and silver halide particles do not stick to the portion that comes in contact with a coating solution in spite of the coating for a long time, and excellent coating quality having uniform layer thickness in the direction perpendicular to the coating direction and having less coating defects while keeping the conventional easy cleaning of the die coater can be obtained. The method of producing a die coater of the invention is effective for die coaters for performing wide web coating with a width of 1 m or larger, and particularly effective for die coaters for performing wide web coating with a width ranging from 1 to 4 m.

A support to be used in practicing the invention is not limited in type, and for example, a paper sheet, a plastic film, and a metal sheet can be used. As paper sheets, resin coat papers and composite papers can be applied, for example. As plastic films, polyolefin film (for example polyethylene film, polypropylene film), polyester film (for example, polyethylene terephthalate film, 2,6-polyethylene naphthalate film), polyamide film (for example polyeter ketone film), cellulose acetate (for example cellulose triacetate) may be usable. As metal sheets, aluminum plates are representative. Further, there is no particular limit on the thickness of a support to be employed.

A liquid coating composition to be employed in practicing the invention is not limited particularly, and it is allowed to use, for example, liquid coating compositions for photographic photosensitive materials, thermal development recording materials, abrasion recording materials, magnetic recording media, steel plate surface treatment, and electrophotographic photoreceptors (including liquid coating compositions for subbing, overcoating, and a backside layer).

Among these, particularly preferable are liquid coating compositions for photoreceptive layers which are liquid coating compositions for thermal development photoreceptive materials and contain a silver component, and liquid coating compositions for non-photoreceptive protective layers.

### EXAMPLES

The present invention will now be described with reference to examples. However, the present invention is not limited thereto.

### Example 1

A light-sensitive layer liquid coating composition containing organic silver was prepared based on the method described below.

<Light-Sensitive Layer Liquid Coating Composition>

<<Preparation of Silver Halide Emulsion A>>

Dissolved in 900 ml of water were 7.5 g of gelatin and 10 mg of potassium bromide, the resulting solution was maintained at 35° C. and the pH was adjusted to 3.0, thereafter, 370 ml of an aqueous solution containing 74 g of silver nitrate and 370 ml of an aqueous solution containing potassium bromide and potassium iodide at a mol ratio of (98/2), as well as an [Ir(NO)Cl6] salt in an amount of 1×10-6 mol per mol with respect to mol of silver, and rhodium chloride in an amount of 1×10-6 mol with respect to mol of silver were added employing a controlled double jet method while maintaining pAg at 7.7.

Thereafter, 4-hydroxy-6-methyl-1,3,3a,7-tetraazaindene was added and the pH of the resulting mixture was adjusted to 5 by the addition of NaOH, whereby cubic silver iodobromide grains at an average grain size of 0.06 mm, a degree of monodispersion of 10 percent, a variation coefficient of the projected diameter area of 8 percent, and a [100] plane ratio of 87 percent were prepared.

The resulting emulsion was coagulated employing gelatin coagulants, and then desalted, thereafter, 0.1 g of phenoxyethanol was added and the pH and pAg of the resulting mixture were adjusted to 5.9 and 7.5, respectively, whereby a silver halide emulsion was prepared.

In addition, the resulting silver halide emulsion underwent chemical sensitization employing chloroauric acid and inorganic sulfur, whereby Silver Halide Emulsion A was prepared.

The above-mentioned degree of monodispersion and variation coefficient of projected diameter area were calculated employing the formulas below:
Degree of monodispersion(in percent)=(standard deviation of grain diameter)/(average value of grain diameter)×100
Variation coefficient of projected diameter area(in percent)=(standard deviation of projected diameter area)/(average value of projected diameter area)×100
<<Preparation of Sodium Behenate Solution>>

Under vigorous stirring, 32.4 g of behenic acid, 9.9 g of arachidic acid, and 5.6 g of stearic acid were dissolved at 90° C. in 945 ml of pure water.

Subsequently, while still vigorously stirring, 98 ml of an aqueous 1.5 mol/L sodium hydroxide solution was added.

After adding 0.93 ml of concentrated nitric acid, the resulting mixture was cooled to 55° C. and stirred for 30 minutes, whereby a sodium behenate solution was prepared.

(Preparation of Pre-Formed Emulsion)

Added to the above-mentioned sodium behenate solution was 15.1 g of the aforesaid Silver Halide Emulsion A, and the pH of the resulting mixture was adjusted to 8.1 by the addition of sodium hydroxide. Thereafter, 147 ml of a 1 mol/L silver nitrate solution was added over a period of 7 minutes. The resulting mixture was stirred for an additional 20 minutes, and water-soluble salts were removed utilizing ultrafiltration.

The resulting silver behenate was comprised of particles at an average particle size of 0.8 mm and a degree of monodispersion of 8 percent. After forming flakes of the dispersion, water was removed.

Thereafter, water washing was repeated 6 times, and water was then removed, followed by drying. Subsequently, 544 g of a methyl ethyl ketone solution (17 percent by weight) of polyvinyl butyral (at an average molecular weight of 3,000) and 107 g of toluene were gradually added and stirred, then, the resulting mixture was dispersed at 27.6 MPa, employing a media homogenizer, whereby a pre-formed emulsion was prepared.

<Preparation of Light-Sensitive
Layer Liquid Coating Composition>

| | | |
|---|---|---|
| Pre-formed emulsion | 240 | g |
| Sensitizing Dye 1 | | |
| (0.1 percent methanol solution) | 1.7 | ml |
| Pyridiniumpromideperbromide | 3 | ml |
| (6 percent methanol solution) | | |
| Calcium bromide | 1.7 | ml |
| (0.1 percent methanol solution) | | |
| Antifogging Agent 1 | 1.2 | ml |
| (10 percent methanol solution) | | |
| 2-(4-chlorobenzoylbenzoic acid | 9.2 | ml |
| (12 percent methanol solution) | | |
| 2-mercaptobenzimodazole | 11 | ml |
| (1 percent methanol solution) | | |
| Tribromomethylsulfoquinoline | 17 | ml |
| (5 percent methanol solution) | | |
| Developing Agent 1 | 29.5 | ml |
| (20 percent methanol solution) | | |

Sensitizing Dye 1

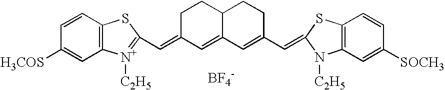

Antifogging Agent 1

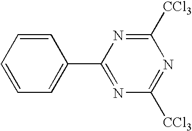

Developing Agent 1

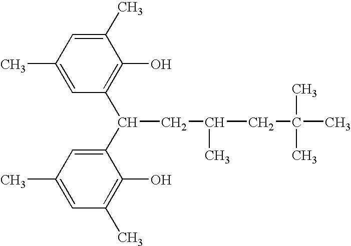

<Preparation of Die Coater>

| <<Preparation of Surface | | |
|---|---|---|
| Protective Layer Liquid Coating Composition>> | | |
| Acetone | 35 | ml/m² |
| Methyl ethyl ketone | 17 | ml/m² |
| Cellulose acetate | 2.3 | g/m² |
| Methanol | 7 | ml/m² |
| Phthalazine | 250 | mg/m² |
| 4-methylphthalic acid | 180 | mg/m² |
| Tetrachlorophthalic acid | 150 | mg/m² |
| Tetrachlorophthalic anhydride | 170 | mg/m² |
| Matting agent: monodipsersed silica | 70 | mg/m² |
| at a degree of monodispersion of 10 | | |
| percent and an average particle size of 4 μm | | |
| C₉H₁₉—C₆H₄—SO₃Na | 10 | mg/m² |

<Preparation of Die Coater>

The slide type die coaters shown in FIG. 1 were prepared employing the method below and designated as 1-1-1-17.

When preparation, the portion in contact with a liquid coating composition of each of the width 1,500 mm wide stainless steel (SUS 630) bars which constituted the slide type die coater, was covered with a fluorine based resin by changing a temperature of a baking process as shown in Table 1, thereby producing the bars, and these bars were arranged whereby a slide type die cater was prepared.

Employed as a fluorine based resin was PRFE and the thickness of the fluorine resin was set at 100 μm.

TABLE 1

| | Baking | Portions to be covered with fluorine based resin | | | | | |
|---|---|---|---|---|---|---|---|
| | temperature | Inside | Inside | | Lip | Outer walls | |
| Die | For fluorine | wall of | wall of | | section | continuing | |
| Coater | based resin | Pocket | Slit | Slide | and Edge | to Lip | |
| No. | (° C.) | Section | Section | surface | section | section | Remarks |
| 1-1 | 300 | Yes | Yes | Yes | Yes | Yes | Inv. |
| 1-2 | 300 | Yes | Yes | Yes | Yes | No | Inv. |
| 1-3 | 300 | Yes | Yes | Yes | No | No | Inv. |
| 1-4 | 300 | Yes | Yes | No | No | No | Inv. |
| 1-5 | 300 | Yes | Yes | Yes | Yes | Yes | Inv. |
| 1-6 | 90 | Yes | Yes | Yes | Yes | Yes | Comp. |
| 1-7 | 100 | Yes | Yes | Yes | Yes | Yes | Inv. |
| 1-8 | 380 | Yes | Yes | Yes | Yes | Yes | Inv. |
| 1-9 | 400 | Yes | Yes | Yes | Yes | Yes | Com. |

Yes: Covered,
No: Not covered,
Inv.: Inventive,
Com. Comparative

When producing each slid type die coater 1-1 to 1-9, the thermal pretreatment for a bar was not carried out and a covering process was performed with a fluorine based resin.

Further, after the baking process after the covering process with the fluorine based resin, the straightness was made to be 5 μm by the final grinding process and the portions covered with the fluorine based resin were polished to result in the surface roughness Ra of 0.1 μm and Rmax of 0.5 μm.

Grinding processing was performed using Column type precision surface grinding machine manufactured by Okamoto Machine Tool Works, and the thickness of the fluorine based resin was measured with a static capacity type minute displacement detector manufactured by Ono Sokki Surface roughness Ra and Rmax were determined employing Surftest SJ-201P, manufactured by Mitsutoyo, Ltd. Straightness was determined as follows. A commercially available laser displacement sensor was fixed to a grindstone holder of the grinder employing a magnet chuck and the bar which was installed on the grinder to be parallel to the moving direction was linearly moved, and displacements in the horizontal direction on the vertical plane of the bar were determined across the total length of the bar, and the differences between the maximum value and the minimal value at every 1 m of the length of the bar were recorded.

<Coating>

Viscosity m (Pa.s) of the light-sensitive layer liquid coating composition prepared as above was adjusted to approximately 0.5 Pa.s, while viscosity m (Pa.s) of the protective layer liquid coating composition was adjusted to approximately 1.0 Pa.s. Subsequently, the resulting liquid coating compositions were applied onto a support which was prepared by connecting 10 belt shaped supports (comprised of PET) at a thickness of 175 mm and a width of 1,500 mm at a coating rate of 30 m/minute, employing each of the coating devices provided with each of the slide type die coaters 1-1-1-9 (which was used for one year under normal temperature), so that a light-sensitive layer was arranged as a lower layer at a coated weight of 75 g/m², and the protective layer was arranged as an upper layer at a coated weight of 25 g/m², and the resulting coating was dried, whereby Samples 101-109 were prepared.

Viscosity was determined employing ROTOVISCO RV-12 of Haake, Inc. and viscosity at each shearing was determined. The pipes covered with a fluorine based resin (PTFE) were employed in a liquid coating composition feeding channel section.

<Evaluation>

The coating layer thickness distribution in the lateral direction and the number of resulting streaks on Samples 101-109 were determined. Table 2 shows the results.

The coating layer thickness distribution in the lateral direction was evaluated based on the evaluation rankings described below.

In addition, the streak trouble generating number shows the result of having observed visually the sample after coating and drying over the overall length of the coated matter.

Incidentally, the coating layer thickness distribution in the lateral direction was obtained such that the coating layer thickness from the end of the coating to 100 m was recorded at an interval of 50 mm across the width, and the ratio of the difference between the maximum value and the minimum value to the average value was calculated and expressed as a percentage.

The coating layer thickness was measured as follows, while employing an electrical micrometer MINICOM M, manufactured by Tokyo Seimitsu Co., Ltd., total thickness at one point of a sample was measured, thereafter, the coating layer of the same point was dampened with methyl ethyl ketone and removed employing nonwoven fabric, whereby the thickness of the support was determined, and the difference between these values was designated as the coated layer thickness. Evaluation rankings for the coating layer thickness distribution in the lateral direction

A: Coating layer thickness distribution in the lateral direction was 0.1-1.0 percent

B: Coating layer thickness distribution in the lateral direction was 1.0-2.5 percent

C: Coating layer thickness distribution in the lateral ion was 2.5-5.0 percent

D: Coating layer thickness distribution in the lateral ion was 5.1-9.9 percent

E: Coating layer thickness distribution in the lateral ion was 9.9 percent or more

TABLE 2

| | Die | Thickness | Number of | |
|---|---|---|---|---|
| Sample | Coater | Distribution in | Streak trouble | |
| No. | No. | Lateral Direction | occurrence | Remarks |
| 101 | 1-1 | A | 0 | Inv. |
| 102 | 1-2 | A | 1 | Inv. |
| 103 | 1-3 | A | 2 | Inv. |
| 104 | 1-4 | A | 4 | Inv. |
| 105 | 1-5 | A | 5 | Inv. |
| 106 | 1-6 | A | 59 | Comp. |
| 107 | 1-7 | A | 7 | Inv. |
| 108 | 1-8 | B | 0 | Inv. |
| 109 | 1-9 | C | 0 | Comp. |

Inv.: Inventive,
Com. Comparative

Incidentally, occurrence of a scratch was observed in the fluorine based resin surface of the die coater used for production of Sample 106.

As shown in the above table, when the heat treatment temperature was 100 to 380° C., coating layer thickness distribution in the lateral was good and no streak trouble occurred, accordingly, the effectiveness of this invention was confirmed.

### Example 2

<Light-Sensitive Layer Liquid Coating Composition>

The light-sensitive layer liquid coating composition as prepared in Example 1 was employed.

<Preparation of Die Coater>

The surface protective layer liquid coating composition as prepared in Example 1 was employed.

<Preparation of Die Coater>

The slide type die coaters shown in FIG. 1 were prepared employing the method below and designated as 2-1-2-11.

When preparing, each of the 1,500 mm wide stainless steel (SUS 630) bars which constituted the slide type die coater was subjected to a grinding process to remove distortion caused by change of a preheating temperature and after the preheating as shown in Table 3. Thereafter, the portion in contact with a liquid coating composition was covered with a fluorine based resin by changing the temperature of the baking process, thereby producing bars, and these bars were assembled, whereby a slide type die coater was prepared.

As for all other condition, it was produced by the same method as an example 1.

TABLE 3

| | | Baking | Portions to be covered with fluorine based resin | | | | | |
|---|---|---|---|---|---|---|---|---|
| | | temperature | Inside | Inside | | Lip | Outer walls | |
| Die | Preheat | For fluorine | wall of | wall of | | section | continuing | |
| Coater | Temp. | based resin | Pocket | Slit | Slide | and Edge | to Lip | |
| No. | (° C.) | (° C.) | Section | Section | surface | section | section | Remarks |
| 2-1 | 1000 | 380 | Yes | Yes | Yes | Yes | Yes | Inv. |
| 2-2 | 1000 | 380 | Yes | Yes | Yes | Yes | No | Inv. |
| 2-3 | 1000 | 380 | Yes | Yes | Yes | No | No | Inv. |
| 2-4 | 1000 | 380 | Yes | Yes | No | No | No | Inv. |
| 2-5 | 1000 | 380 | Yes | Yes | Yes | Yes | Yes | Inv. |
| 2-6 | 750 | 90 | Yes | Yes | Yes | Yes | Yes | Comp. |
| 2-7 | 750 | 100 | Yes | Yes | Yes | Yes | Yes | Inv. |
| 2-8 | 750 | 380 | Yes | Yes | Yes | Yes | Yes | Inv. |
| 2-9 | 750 | 400 | Yes | Yes | Yes | Yes | Yes | Comp. |
| 2-10 | 300 | 380 | Yes | Yes | Yes | Yes | Yes | Comp. |
| 2-11 | 380 | 380 | Yes | Yes | Yes | Yes | Yes | Inv. |

Yes: Covered,
No: Not covered,
Inv.: Inventive,
Com. Comparative

Final grinding and polishing processes were performed employing the same method as for Example 1.

Moreover, the straightness, the thickness and the surface roughness of fluorine based resin were measured by the same method as an example 1.

<Coating>

Each produced slid type die coater 2-1 to 2-11 which was used for one year under normal temperature was used, coating and drying were performed by the same condition and method as an example 1, and samples 201-211 were produced.

<Evaluation>

The coated layer thickness distribution of each of resulting Samples 801-826 was determined employing the same method as for Example 1 and evaluated employing the same rankings as for Example 1, and Table 4 shows the results.

TABLE 4

| | Die | Thickness | Number of | |
|---|---|---|---|---|
| Sample | Coater | Distribution in | Streak trouble | |
| No. | No. | Lateral Direction | occurrence | Remarks |
| 201 | 2-1 | A | 0 | Inv. |
| 202 | 2-2 | A | 0 | Inv. |
| 203 | 2-3 | A | 1 | Inv. |
| 204 | 2-4 | A | 3 | Inv. |
| 205 | 2-5 | A | 4 | Inv. |
| 206 | 2-6 | A | 77 | Comp. |
| 207 | 2-7 | A | 5 | Inv. |
| 208 | 2-8 | B | 0 | Inv. |
| 209 | 2-9 | C | 0 | Comp. |
| 210 | 2-10 | D | 0 | Comp. |
| 211 | 2-11 | B | 0 | Inv. |

Inv.: Inventive,
Com. Comparative

Incidentally, occurrence of scratch was observed in the fluorine based resin surface of the die coater used for production of Sample 206.

As shown in the above table, when the heat treatment temperature was 100 to 380° C. after the preheating was conducted at a temperature equal to or higher than the baking temperature, coating layer thickness distribution in the lateral was good and no streak trouble occurred, accordingly, the effectiveness of this invention was confirmed.

### Example 3

When producing the die coater 2-1 shown in Table 3 of Example 2, as shown in Table 5, except that the straightness of the surface in the direction of coating width after the surface coating process with a fluorine based resin was changed by grinding processing, the bar was produced on the same condition as Example 2, these bars were assembled to produce the die coater referred to as 3-1 to 3-7.

Incidentally, measurement of the thickness of fluorine based resin, surface roughness, and straightness was performed by the same method as Example 1.

TABLE 5

| | Straightness (μm) of |
|---|---|
| Die Coater | portions covered with |
| No. | fluorine based resin |
| 3-1 | 0.08 |
| 3-2 | 0.1 |
| 3-3 | 1.0 |
| 3-4 | 5.0 |
| 3-5 | 8.0 |
| 3-6 | 10.0 |
| 3-7 | 11.0 |

<Coating>

The produced slid type die coater 3-1 to 3-7 which was used for one year under normal temperature was used, coating and drying were performed for them on the same condition as an example 1, and samples 301-307 were produced.

<Evaluation>

To each obtained Samples 301-307, by the same method as an Example 1, coating thickness distribution along a width direction is measured and the results evaluated by the same evaluation rank as Example 1 are shown in Table 6.

TABLE 6

| | Die | Coating Layer Thickness |
|---|---|---|
| Sample | Coater | Distribution in the |
| No. | No. | Lateral Direction |
| 301 | 3-1 | A |
| 302 | 3-2 | A |
| 303 | 3-3 | A |
| 304 | 8-4 | A |
| 305 | 3-5 | A |
| 306 | 3-6 | A |
| 307 | 3-7 | A |

Incidentally, although the performance of the die coater used for Sample 301 was good, since a production man-hour became huge and the cost was too expensive for producing a bar, it was judged that a practical utilization was difficult. As shown in the above table, since the straightness was 0.1 to 10 μm and the coating layer thickness distribution in the lateral was good, accordingly, the effectiveness of this invention was confirmed.

### Example 4

When producing the die coater 2-1 shown in Table 3 of Example 2, as shown in Table 7, except that the surface roughness in the direction of coating width after the surface covering process with a fluorine based resin was changed, the bar was produced on the same condition as an example 2, these bars were attached such that the die coater was produced, and these was referred to as 4-1 to 4-11.

Incidentally, except that the preheat treatment for a bar was performed by the same method as the die coater 2-1 and covering with a fluorine based resin was not performed, the bars was produced on the same condition, these bars were assembled such that the comparative die coater was produced, and it was referred to as 4-12.

Moreover, measurements of straightness, thickness of fluorine based resin and surface roughness were performed by the same method as an example 1.

TABLE 7

| | |
|---|---|
| Die | Roughness of Surface Covered |
| Coater | with Fluorine Based Resin |

| No. | Ra (μm) | Rmax |
|---|---|---|
| 4-1 | 0.01 | 0.5 |
| 4-2 | 0.02 | 0.5 |
| 4-3 | 0.05 | 0.5 |
| 4-4 | 0.1 | 0.5 |
| 4-5 | 0.9 | 0.5 |
| 4-6 | 1.0 | 0.5 |
| 4-7 | 0.1 | 0.1 |
| 4-8 | 0.1 | 0.2 |
| 4-9 | 0.1 | 1.0 |
| 4-10 | 0.1 | 4.0 |
| 4-11 | 0.1 | 5.0 |
| 4-12 | 0.1 | 0.5 |

<Coating>

Coating and drying were performed by the same condition and method as an example 1, and samples 401-412 were produced.

<Evaluation>

For each of obtained samples 401-412, by the same method as Example 1, the numbers of streak trouble occurrences was measured and the results evaluated by the same evaluation rank as an example 1 are shown in a table 8.

TABLE 8

| Sample | Die Coater | Number of streak |
|---|---|---|
| No. | No. | trouble occurrence |
| 401 | 4-1 | 0 |
| 402 | 4-2 | 0 |
| 403 | 4-3 | 0 |
| 304 | 4-4 | 1 |
| 405 | 4-5 | 3 |
| 406 | 4-6 | 10 |
| 407 | 4-7 | 0 |
| 408 | 4-8 | 0 |
| 409 | 4-9 | 1 |
| 410 | 4-10 | 4 |
| 411 | 4-11 | 11 |
| 412 | 4-12 | 25 |

Incidentally, although the die coater performance used for producing samples 401 and 407 was good, since the production man-hour became huge and the coast was too expensive, it was judged that a practical utilization of the die coater was difficult.

As shown in the above table, since the surface roughness was within a range of 0.01 μm<Ra<1 μm and 0.1 μm<Rmax<5 μm and no streak trouble occurred, accordingly, the effectiveness of this invention was confirmed.

1. A method of producing a die coater structured with at least two bars so as to form a pocket section to extend a coating liquid in a coating width direction, a coating liquid supply port to supply a coating liquid to the pocket section, and a slit section to discharge a coating liquid from the pocket section to a material to be coated, wherein at least a part of a surface of the two bars coming in contact with a coating liquid is covered with a fluorine-based resin, the method comprising:
a covering process of covering a part of a surface of a bar coming in contact with a coating liquid with a fluorine-based resin; and
a baking process of baking the fluorine-based resin covering the part of the surface of the bar at a temperature of 100 to 380° C.

2. The method of claim 1, further comprising:
a finishing grinding process of finishing the surface of the bar, wherein the fluorine-based resin is covered with a thickness thicker than a predetermined thickness in the covering process, the covered fluorine-based resin is baked in the baking process, and then the excess part of the covered fluorine-based resin thicker than the predetermined thickness is removed by the finishing grinding process.

3. The method of claim 1, wherein the finishing grinding process finishes the surface of the bar covered with the fluorine-based resin so as to have a straightness of 0.1 to 10 μm in a direction along a coating width.

4. The method of claim 1, wherein the finishing grinding process finishes the surface of the bar covered with the fluorine-based resin so as to have a surface roughness satisfying the following formulas:
0.01 μm<Ra<1 μm and 0.1 μm<Rmax<5 μm

5. The method of claim 1, further comprising:
a preheating process of preheating the bar at a temperature equal to or higher that the baking temperature, and
a preliminary grinding process of removing a deformation caused by the preheating process.

6. The method of claim 1, wherein as the fluorine-based resin, a polytetrafluoroethylene (PTFE), a tetrafluoroethylene-perfluoroalkylvinylether copolymer (PFA), a tetrafluoroethylene-hexafluoropropylene copolymer (FEP), an ethylene-tetrafluoroethylene copolymer (ETFE), a polychlorotrifluoro ethylene copolymer (PCTFE), a chlorotrifluoroethylene-ethylene copolymer (ECTFE), a PVF (PVF), a polyvinylidene fluoride (PVDF), etc. are usable.

7. The method of claim 6, wherein as the fluorine-based resin, a tetrafluoroethylene-hexafluoropropylene copolymer (FEP), ethylene-tetrafluoroethylene copolymer (ETFE) and chlorotrifluoroethylene-ethylene copolymer are usable.

8. The method of claim 1, wherein the fluorine-based resin is dispersed in a thermosetting resin to form a coating solution and is coated with the coating solution.

9. The method of claim 8, wherein as the thermosetting resin, a phenol resin (PF), a urea resin (UF), a melamine resin (MF), an epoxy resin (EP), a unsaturated polyester resin (UP), a diallylphthalate resin (PDAP), a polyimide resin (PI), a polyamide-imide resin (PAI), a silicone resin (SI), ect. are usable.

10. The method of claim 9, wherein as the thermosetting resin, a polyamide-imide resin is usable.
